(19) United States
(12) Patent Application Publication
(10) Pub. No.: US 2013/0045341 A1
(43) Pub. Date: Feb. 21, 2013

(54) Translucent photographic media viewable from both sides

(71) Applicant: Paul Ramsden, Lisbon, ME (US)

(72) Inventor: Paul Ramsden, Lisbon, ME (US)

(73) Assignee: SOLAPIX LLC

(21) Appl. No.: 13/506,593

(22) Filed: Apr. 30, 2012

Related U.S. Application Data
(60) Provisional application No. 61/518,125, filed on Apr. 29, 2011.

(51) Int. Cl. B44F 1/06; B05D 5/04; B32B 38/14; B32B 27/08; B32B 3/02

(52) U.S. Cl. 428/13; 428/213; 428/195.1; 156/280; 427/261

(57) ABSTRACT

A photographic print media comprising: a transparent synthetic organic polymeric layer adjacent and affixed to an opaque or semi-transparent translucent synthetic organic polymeric layer host to light scattering whitening particulate and diffused dyestuff. The invention as disclosed provides for a novel new method of creating and displaying digital images in a media that provides for photographic quality full color images to be printed with translucency and the ability to view the image from both sides.

I hereby claim priority to my previous provisional patent application No. 61/518,125 filing date Apr. 29, 2011

### FIELD OF THE INVENTION

The present invention relates to photographic reproductions. Specifically, the present invention relates to a novel media and decorative process. More specifically, the invention provides for photographic reproductions on a new media that exhibits a unique and novel array of properties that include translucency combined with transparency that can be application-specific and customizable from highly transparent to completely opaque. The present invention provides for rendering a photographic quality image completely viewable from both sides of the media upon which it has been printed. Additionally the present invention provides for a media capable of displaying the afore-described graphics in continuous tone, high resolution, vibrant digital color; while also providing flexibility, and a high degree of durability and permanence. Furthermore the invention provides for the encasement and encapsulation of the afore-photographic media in a transparent polymeric layered assembly, for the purpose of framing, supporting and enhancing its aesthetic quality, adding thickness, adding weight, and enhancing the durability of the image. The said layering also serving to render the photographic medium a component suitable for deployment within an array of different end-product designs.

### BACKGROUND OF THE INVENTION

In the digital printing industry, more specifically the photo-finishing sector, there is a growing demand for ‘photo-gifts’. Photo gifts comprise products customized with the consumer's own photographs. This industry emerged in the 1990's with computer mouse-pads, mugs and T-Shirts; and evolved quickly into a mass customization industry offering a plethora of products through websites and interactive retail photo-kiosks.

The significant growth in this industry has been fueled by (a) increasing confidence and traffic in an expanding e-commerce marketplace (b) the increase in digital photography at consumer level, (c) the deployment of consumer interactive photo kiosks in virtually every major chain store, and (d) the increase in products diversity and decrease in production costs associated with these customized items.

At the center of this industry is the dye sublimation photo printer, which enables the rapid and affordable printing of photographs at retail level. Consumers can crop, render and add text, clip art and borders to their photographs on user-friendly point-of-sale kiosks before printing the photographs there and then; these kiosks also have the capability of charging the customer's credit card thus avoiding the need for the consumer to stand in line to pay elsewhere in the retail store.

Supplemental to the opportunity for the consumer to render and print their own photographs right there in the store, these interactive kiosks offer consumers a range of ‘photo-gifts’, thereby enabling the consumer to turn their photos into a range of customized gift items including mugs, key-chains, tote-bags, mouse-pads etc. When placed, the order for these products is sent digitally to a fulfillment center which handles production and shipping, and within a few days the product is shipped directly to the consumer or the nominated recipient.

At the center of the fulfillment production process is the inkjet and laser printer, modified to deposit disperse dyes onto transfer media which is subsequently heat pressed onto pre-prepared ‘blanks’. A blank photo-gift is simply an item prepared for receiving the image; comprising either a white synthetic organic textile surface such as is found on a t-shirt or mouse-pad; or a synthetic organic clear coated surface, such as would be found on a mug or a tile. Following this transfer printing process which is known as ‘dye-sublimation transfer printing’, the blank becomes a ‘custom decorated photo gift’. The established art of dye-sublimation transfer printing process involves heat and pressure being applied to a disperse-dye based print causing it to diffuse into the synthetic polymer.

Among the products that have recently been introduced to the custom photo gift specialty market are glass and acrylic articles comprising blocks, shapes and curves that are imprinted on their rear side, either by a direct or transfer printing process; and which offer the consumer the opportunity to place their custom decorated ‘photo-gift’ on a horizontal surface for the purpose of viewing the image through the optically clear glass or polymeric ‘face’. The aesthetic advantage of viewing ‘style’ versus the conventional picture frame method is that the image itself exhibits an improved depth and vibrancy. The object, typically ranging in thickness between 3/16″ and 1″, reflects and refracts light as does the image itself which, when combined, creates a prism effect adding a third dimension to the image. These imaged articles can be supported by posts or stands, or free-standing; sometimes the thickness and shape eliminates the requirement for a post or stand. In some cases, and depending often upon the chemistry and process employed in the printing of the article, the image is partially viewable from the back side of the article which improves its visibility and aesthetic quality when the article is placed on a desk or coffee table; as such are locations where viewers might typically walk around it.

Other new and popular products in the photo gift industry include a new generation of picture frames that incorporate the afore described product design, but rather than the product being permanently imaged on one side of the article, it allows for the consumer to insert a photograph into the article; thus the afore-mentioned benefits of clear encasement of the photograph are afforded, while permitting the replacement of the photograph as the consumer so desires. These products which typically comprise glass or acrylic require that the photograph slide into a void within the article, either from the top, side or base. These transparent frames allow the consumer to put a single image into the assembly, which is then viewable from one side; or to insert two photographs back-to-back into the assembly, thus allowing 2 images to be viewed, one from each side. As stated, the key advantage of this product line is that the image contained within the clear block or shape can be changed from time to time.

It can be noted therefore that there is an existing demand and market for blocks and shapes comprising a clear organic or inorganic medium, typically acrylic or glass; which either displays photographic images permanently imprinted on the rear side of the article, or temporarily displays conventional photographs placed within the article. Furthermore it can be noted that when a single photograph is exhibited, the image is viewed from the front of the article only, whereas when 2 photographs are exhibited back-to-back, the images can obviously be viewed from both front and back sides.

In addition to a variation in functionality between the two types of clear photo gift items discussed, there is another factor to be considered, and that is aesthetics. Photographs have remained constant in their appearance for many decades. The greatest significant changes in this industry have been the progression from black-and-white to color, and the advent of digital photography which has enabled significant improvements to the rendering and printing processes, as well as reducing the costs and complexities of converting the image captured by the camera, to a print. The art of digital photography, including the rendering and printing aspects, is now undertaken by a vast number of consumers in an amateur capacity; and an increasing number in a semi-professional capacity. The popularity of the art, and the increased demand for customization at retail level, are the driving forces behind the rapid growth photo gifting specialty market.

Despite the progress in the rendering and printing, and consumer enthusiasm, the photographs themselves have changed very little. Whether they are printed in an inkjet printer at home, or on a highly specialized high-volume dye-sublimation printer in a pharmacy or photo-finishing studio, they remain a thin layer of dye printed directly onto a coated white paper. In the case of dye sublimation printers a laminate is applied by the printer subsequent to the printing process; which protects the image and enhances its appearance. Either way, whichever printing process is employed the output results in a print that is opaque and that offers little to negligible translucency. If the printed photograph is placed in a frame and positioned in such a way that it does not have light shining upon it, or ambient lighting to illuminate it, then it will not appear vibrant. If lighting exists behind it then it may fall within a shadow and thus its visibility is further reduced. To reiterate, a photograph today, remains as it has for several decades; that being an imaged article comprising an opaque white media with dyes organized on one side of it to create a graphic image that is intended to be viewed from one side only.

So the present invention relates principally to creating a new type of photograph. To understand the novel concept presented herein it is worth reiterating and further exploring the reasons why photographs are only one sided:

Firstly it is due to the fact that photographs are printed using dyes not pigments, and no white disperse dye is employed for photographic printing. Disperse dye is the dye group employed in thermal diffusion printing. Were pigments to be employed to produce photographs it might be argued that a white pigment could be printed onto a photograph; however pigments lack the translucency and therefore color gamut necessary to produce the photographic quality that is synonymous with the art. Thus in the current art photographs remain to be dyes printed upon a white background which affords both the whiteness of the image to be gained from the background, and the light reflection necessary to illuminate the dyes which results in the colors and vibrancy of the image.

Secondly, and as a consequence of the first factor, were a photograph to be printed upon a clear substrate, such as employing a clear film instead of a paper, then the image would lack density. It would appear similar to a photographic slide, which when projected on a white background with a back light appears pleasing to the eye, whereas when viewed without a white background or back-light appears washed out and lacking in color and density.

A third factor pertains to the diffusion of the disperse dyes used in photographic printing. The process employed today takes solid disperse dyes attached to a ribbon and, while applying heat and pressure, diffuses the dye into a receptive thermoplastic polymer coating on the paper. The dyes do not diffuse very deeply into the coating, typically <5 micron(s). Therefore, if dyes were intended to diffuse all the way through a thicker film; hypothetically passing through an intermediate white reflective layer and diffusing into a clear layer on the other side of the photograph, the migration would not be sufficient to the degree necessary to render the photograph ‘double sided’—or in other words ‘viewable from both sides’.

Thus photographs are printed upon a white light-reflective paper or hybrid materials acting as a support, and it is this very layer, whether paper or other material, which prohibits the image from being visible from the opposing side to that printed.

Finally, it is worth reiterating some of the physical properties of a photograph when placed in a picture-frame; whether such is a clear block or shape, or a conventional frame with a border and backing employing a clear glass or plastic sheet placed over the image. These conventional products require ‘front lighting’ for the image to be seen clearly, particularly in low light situations. For example if a framed photograph is on a desk or window sill in low lighting, it requires illumination from the front for it to be clearly visible. If lighting is positioned behind the framed image, then the shadow cast by the frame itself limits the visibility and diminishes the appearance of the photograph.

Conversely, in the case of photo products that employ an image printed upon the rear side of clear acrylic and glass blocks, when they are illuminated from the front they are clearly visible; however when they are illuminated from the rear side they are highly visible also. This is a very aesthetic and desirable feature that is unique to this style of photo product. Such aesthetics come at a price to the consumer however. Since the photographic image in this style of product is permanently fused to the article; the acrylic or glass block is permanently attached to the image and vice versa. If the consumer desires to display another image in the manner then a new imaged block is required; in other words each acrylic or glass block is dedicated to one image. If the consumer decides that they no longer wish to display a decorated article and instead to exhibit another then the first, in its entirety, needs to be removed from view and stored, or even disposed of, and another created to take its place. Since blocks of acrylic and glass employed in the production of this type of photo product often incorporate a fair number of cubic inches of plastic or glass, the consumer may rightfully become concerned about the environmental impact of this type of photo product and their desires to display different images from time to time.

From the description of the art thus far it can be seen that it would be desirable to produce a photo reproduction, that could be exhibited within a block or other shape of clear plastic or glass, that afforded the consumer the opportunity to see the image from both sides, and to see the image clearly when only limited back lighting or front lighting was available, and to remove and replace the image as often as the consumer felt inclined to do so.

What would also be desirable would be ability to encase this ‘double-sided-photograph’ in a polymer rendering it a permanent item. Such an encased photograph should have a degree of rigidity or flexibility than can be tailored to its intended purpose, employ an amount of polymer in its encasement that would not exceed the threshold of cause for environmental alarm on the part of the consumer relative to the disposal of the product; and allow the use of the product in a multitude of capacities, be it key-rings, sun-catchers, desk-top photographs, awards, and many more such applications.

What is absent therefore in the vast and increasing array of photo products is a photo printing process that results in colorful images, with vibrancy and density, and highly contrasting black and white tones which can be combined with the depth and luster of the photographic printing process, be viewable from both sides, and that perfectly balances opacity with translucence. The resulting product would then enable the consumer to position their ‘double-sided-translucent-photographs’ into transparent frames which would enable the image to be viewed from both sides of the frame, and enable the image to capture and attenuate light in a highly aesthetic manner lending a three dimensional and iridescent effect to the image.

Furthermore, what would be well received by the industry would be the ability to permanently encase such photographs in a high clarity medium thus expanding upon the current products that offer an image fused to one side of a transparent medium; instead providing for a product that actually permanently encapsulates the image within the transparent medium.

Finally what would be of additional merit would be the ability to produce such double-sided photographs on a rigid transparent polymeric substrate that could be cut into shapes, edge-polished, beveled etc in order to produce highly appealing photo-gifts such as Christmas Ornaments, Suncatchers, and Free-Standing Desk Photo Items.

### BRIEF SUMMARY OF THE INVENTION

The present invention overcomes the aforementioned obstacles while providing for a process and end-product design that achieves all of the desirable properties discussed above.

In the course of trials and research a method of producing a double sided photograph was established the details of which follows.

The fundamental element of the present invention pertains to 2 polymeric layers positioned adjacent to each other; one layer comprising of an optically clear polymer and one layer comprising of a white translucent polymer.

The clear polymer serves as a support and protective layer. Upon it is applied the white layer which receives an image by diffusion or sorption. The whitening of the image-hosting layer provides for the white in the subsequently applied image eliminating the need to incorporate a white pigment or dye in the imaging process.

The clear polymer is optimally between 100 and 500 microns in thickness and is capable of withstanding temperatures exceeding 300 F for a time exceeding 30 seconds. Ideally this clear polymer is 250 microns and capable of withstanding temperatures exceeding 350 F for a time exceeding 3 minutes. For this reason this clear polymer is ideally suited to being polyester although urethane and polycarbonate are also suitable compositions. The clear polymer is ideally an extruded film although as would be well known to those in the art of producing film and rigid polymeric sheet stock could also be cast.

While the image receiving host layer is suited to being an extruded film, it is more optimally a liquid coating cured by air, heat, radiation, or chemical catalyst. The coating would be applied by spray, roll, blade, screen, curtain or inkjet or other form of deposition as would be known to one skilled in the art of applying coatings to film. This coated layer is ideally suited to being a urethane, acrylic or polyester, although other polymer families would not stray from the theme of this invention. The present invention prefers urethane chemistry of a highly crosslinked nature in order to create crisp high resolution images.

Although possible to create the desired effect by employing semi-transparent white pigment of the order 1-10 micron thickness the optimal effects were achieved by incorporating sub-micron white particulate in the host layer that enable the required whiteness and opacity of the end-product while allowing for the desirable translucency to be achieved. For this reason the whitening is accomplished by the use of sub-micron particles with a mean size in the range of 50-400 nm. While these particles can be organic, the best results were found using inorganic oxides.

It was discovered in the course of our research that aluminum oxide nanoparticles in the 50-200 nm range create a unique and highly desirable translucent effect within dye diffused images, causing a variation in luminance and opacity depending upon the ambient light, angle of light incidence, viewing angle, and distance from the image to the light source, surrounding articles and viewer. Also this irradiance was noticed to create desirable effects in the color of images diffused into matrices containing them. Optimal loading levels of these additive materials were when combined in the 2-15% range. The use of larger particle sizes reduced the loading levels necessary to 2-9% by weight. The use of primarily smaller particles increased the loading levels necessary to 6-15% by weight. In all cases the ratio was determined by considering the thickness and the desired whiteness, opacity and translucence of the coating.

It was also discovered that the use of zirconium oxide nanoparticles in the 50-200 nm created a very high degree of whiteness with a very low loading level thus decreasing cost and minimizing the interference between the nanoparticles and the migration of the dyes. Use of Zirconium Oxide in the stated range required only 4-10% by weight depending upon the thickness of the coating and desired whiteness of the coating.

It was further discovered that the use of both alumina and zirconia, either independently or in concert provided a highly desirable increase in scratch, mar and abrasion resistance of the diffused image; while at the same time not interfering with the gloss level of the coating.

We determined that the image receiving layer is ideally 25-100 microns in thickness, optimally 25-50 microns. This polymer, like the clear support polymer, must be capable of withstanding brief exposure to 350 F, and be capable of receiving dyes through diffusion. We found that a higher crosslink density was advantageous for creating very high resolution graphics however in some cases slowed the imaging process down due to the slower flux rate of diffusion of the disperse dyes.

It was also discovered that employing a combination of white nanoparticles with clear inorganic particulate such as ceramic and glass microspheres or other inorganic light attenuators created complementary effects. The clear inorganic particulate served as ‘pigment extenders’ and in some cases also provided useful complimentary effects and enhanced functionality. Effects included increasing opacity in a disproportionate ratio to translucency, in other words opacity could be increased substantially while at the same time translucency only increased marginally. Functionality adaptation included improved mar resistance, improved economics, and in some cases enhanced even improved adhesion.

As an alternative to receiving dyes by diffusion, the imaging layer may be rendered capable of receiving an image through direct printing, in which case the dyes will migrate into the polymer by sorption.

Expanding upon the above points, these fundamental elements can be supported by the following findings.

It was established that were the image receiving layer were to be independent, the film would be too thin to retain its properties during a thermal imaging process; it would buckle, wrinkle and permanently deform. Furthermore such a layer independently would be too flimsy for consumers to employ in their frames as it would lean and bend, and potentially change appearance were it to be subject to localized heat such as on a window sill in summer time, or when placed near a cooker in the kitchen, or above a fireplace.

The necessity was therefore established to support the image receiving layer, said support being necessarily optically clear, as otherwise the image would not be visible from the rear side of the imaged layer. It was determined that this support layer must, in addition to being transparent, be capable of withstanding the heat transfer process subjecting it to 300-400 F for 1-10 minutes. This reduced the selection of economically viable polymers to polyester and polycarbonate.

Through our tests we established that disperse dyes struggle to diffuse past a depth of 75 microns in a receptive film. It was subsequently determined that the image receiving layer is required to be maintained less than 125 microns, although optimally 25-75 microns.

It was further established that white pigments above 1 micron in size interfere with the vibrancy, density, color and translucence of dyes diffused into polymers and therefore to achieve photographic qualities the whitening agents in the image receiving layer should maintain a mean particle size under 400 nm being the threshold of visible light. We discovered that optimally a blend of particles are employed, one group with a smaller mean particle size, and one group with a larger particle size. This allowed for a very good spread of particles from very small (20-80 nm) to comparatively large (100-400 nm) particles. We found additionally that blending particulate provided highly desirable results; namely blending small nanoparticles with a mean size less than 100 nm, with mid sized nanoparticles with a mean size between 100 and 200 nm. These blend resulted in a highly desirable balance between whiteness, opacity and translucence. It was established that combinations of this nature, particularly when hosted by highly crosslinked polymers, provided ultra high resolution of the final photographic image.

Pretreatment of the host film, methods of application, selection of compatible chemistries in so far as adhesion and other such aspects of the invention would be known to those of average skill in the applicable arts.

The initial discovery was therefore that upon applying a thin white nano-composite translucent coating onto a clear film, and subsequently imaging the white translucent film by diffusing dyes into it; it was possible to create a highly appealing photographic product that could be seen from both sides and which provided a desirable balance of translucence and opacity. Attempting to produce a double sided photograph by employing either one of the layers without the other did not result in the desirable product. Thus, diffusing dyes into a clear film without the white layer resulted in a transparent image with no density. Similarly, diffusing dyes into the white layer without the clear layer resulted in a heat distorted film without any useful application. When the two were combined the medium was capable of being heat pressed and receiving an image by diffusion, the clear film served to support the imaged layer and to serve as a clear viewing layer through which the image could clearly be seen without interference.

We determined that, as would be evident to those skilled in the art of applying coatings to films, preshrinking the film that is to be coated assisted with avoiding issues that could potentially stem from differing thermal coefficients and shrinkage propensities.

The finish of the image receiving layer can be tailored, as can the finish of the clear support layer. Each can be finished in gloss, satin or matte finish; either both finishes the same or both different.

Another facet to the present invention was that following imaging, a laminate can be applied over the imaged side thus encasing the imaged layer between 2 clear protective layers. This step prevents the image from bleeding onto other chemistries or products that come into contact with the imaged layer. Sometimes chemistries that come into contact with dye saturated polymers can cause a slight bleeding of dye at the surface of the polymer and thus a clear dye free laminate layer served to complete the encasement of the image and provide additional protection of the image. This also provided for a means of allowing the consumer to purchase a rigid durable double sided photograph that could offer all of the durability of a photograph, including chemical and physical resistance.

Following production, the photograph was highly aesthetically pleasing both independently and when exhibited in an acrylic or glass two-sided photo frame. Whereas conventional photographs are opaque and therefore can only be seen from one side of these popular transparent frames, the two-sided photograph described herein allowed the image to be seen from both sides of the frame, and furthermore for the image to exhibit translucence and transparency.

Another facet to the present invention was that if one takes the double sided photograph one could apply a doming resin to either or both sides of it, thereby affording increased rigidity, aesthetics and protection. The domed photograph could then be offered as a free standing or hanging photo gift and did not require any frame for support. This lead to the design of a range of photo gifts built around this pretence, including Christmas decorations, sun catchers, auto-interior decorations, table-top photo products and other such items. Unlike the double-sided photograph that can be inserted into clear double sided frames and replaced as desired, the doming-resin encapsulated product is a permanent product that requires no additional framing. Its potential applications are vast. Environmentally it is of significantly lower impact than the industry's current acrylic block products that have images permanently fused to them. Additional benefits of the domed product compared to the acrylic block include it being lighter, cheaper to produce, easier to produce shapes, the ability to hang the product, and perhaps above all that the image is completely encapsulated within the final product as opposed to being fused to one side of it.

In summary therefore the present invention provides for a novel new photographic printing process which results in the first ‘double sided photograph’, and an extensive new photo gift product line based upon its temporary placement within transparent frames and permanent encapsulation within doming resins.

### BRIEF DESCRIPTION OF THE DRAWINGS

FIG. 1 provides a cross-sectional view of the present invention, at the instant at which a printed image is diffused into a dye-receptive polymer thus producing the finished printed product

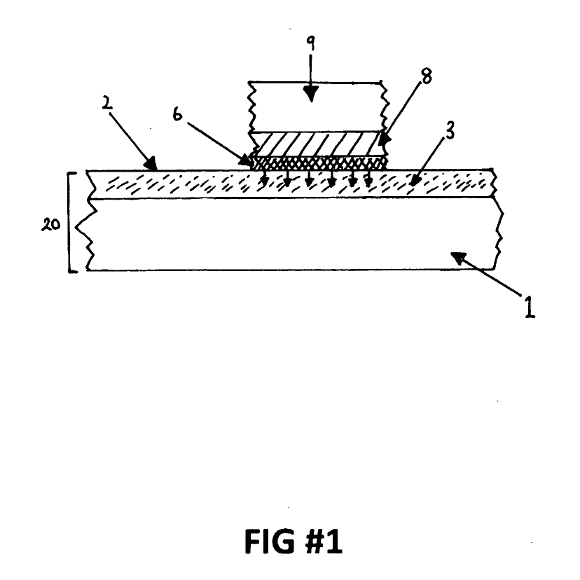

FIG. 2 provides a cross-sectional view of the present invention having been prepared to receive an image by dye-diffusion

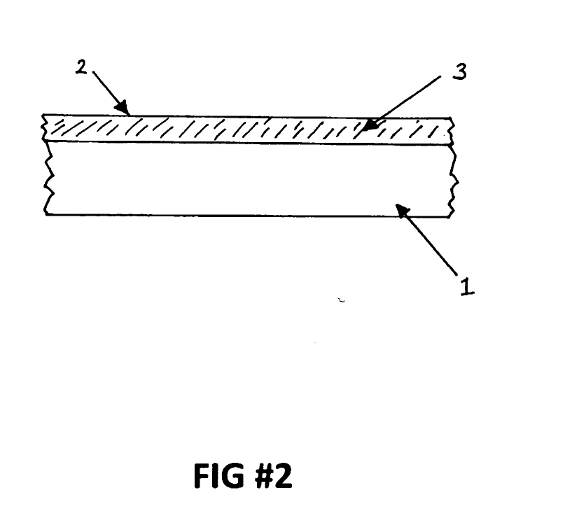

FIG. 3 provides a cross-sectional view of the present invention having been prepared by the co-extrusion process

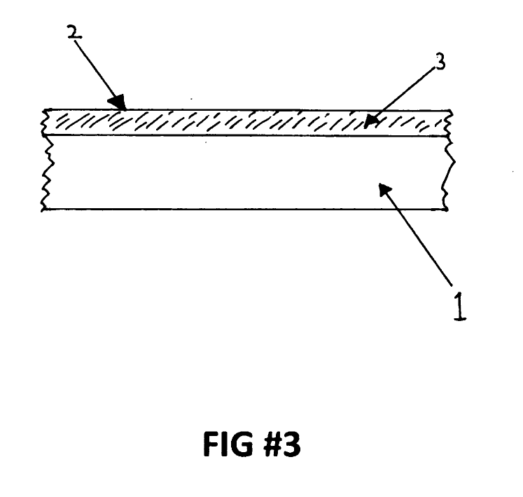

FIG. 4 provides a perspective drawing of the present invention positioned in an acrylic frame

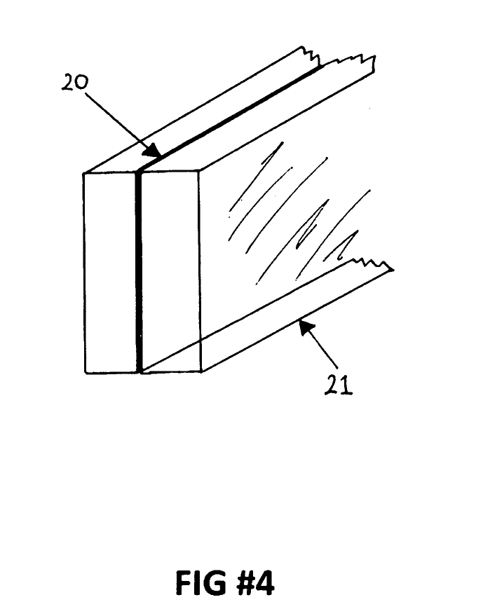

FIG. 5 provides a cross-sectional view of the present invention in an acrylic frame that has subsequently been sealed using an ultraviolet curable resin

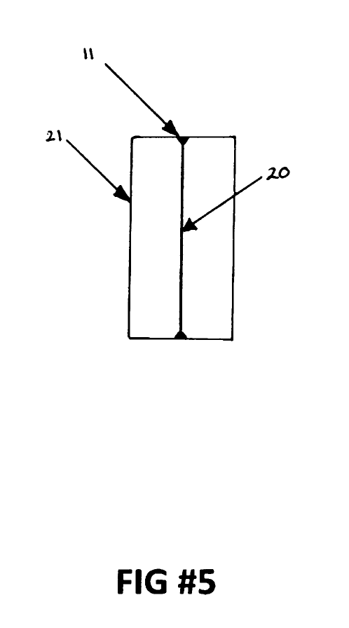

FIG. 6 provides a cross-sectional view of the present invention having been post-treated with a doming resin

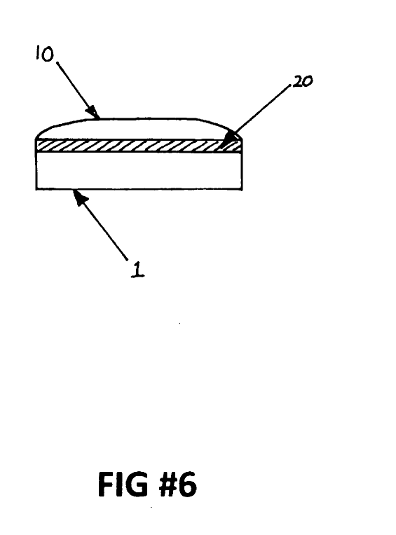

FIG. 7 provides a cross-sectional view of the present invention in the form a coated polycarbonate sheet stock material

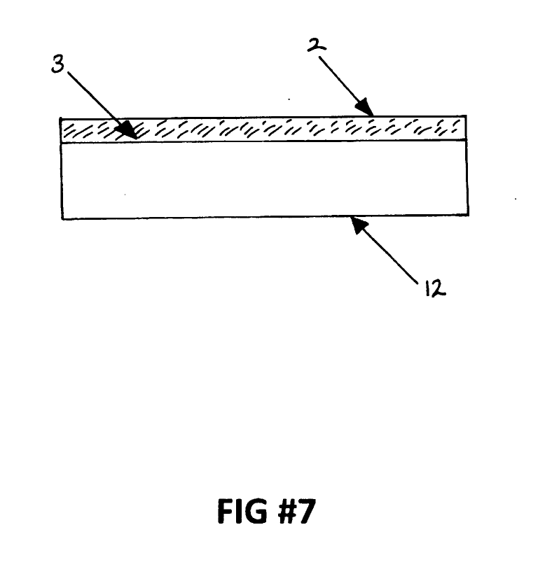

### DETAILED DESCRIPTION OF THE INVENTION

The following Key details the elements in both the descriptions of the preferred embodiments and the accompanying drawings.
1 Clear Heat Resistant Film
2 Image Receptive Polymer
3 Whitening Additive
4 Clear Inorganic Pigment Extender
5 Disperse Dye
6 Graphic Dye
7 Laminate
8 Transfer Paper
9 Heat Platen
10 Doming Resin
11 UV Curable Coating
12 Rigid Polycarbonate Sheet
20 Double Sided Photograph
21 2-Sided Acrylic Picture Frame

In the first embodiment of the present invention, depicted in drawing #1 a double sided photograph is produced. The process for which includes the following steps. First of all a clear heat resistant film 1 has been selected with properties that include heat-resistance, pre-shrunk, UV-resistance, optically clear, and with a surface tension accommodating to coatings being applied. For the purpose of this example we employed an optically clear 250 Micron Mylar™ polyester film manufactured by DuPont. A coating was prepared as follows: a 2-component high-gloss urethane clear coating was blended with 2 dispersions of aluminum oxide nanoparticles 3 with mean sizes in the range of 40 nm and 150 nm; both dispersions were in PMA solvent to aid in letting down into the host solvent-borne polymer. The dispersions provided for an addition by weight to the host polymer of nano solids amounting to 10% and 5% respectively. The composite nano coating 2 was then applied by draw down at a thickness of 40 Microns dry-film-thickness to the polyester film 1 and after a 10 minute flash time was subject to an accelerated cure at 150 F for 60 minutes. Separate to the preparation of the receptive film a printed transfer graphic 8 was prepared using dye sublimation inks 6 in an inkjet printer. The inks 6 were jetted onto a coated transfer paper 8 and allowed to dry in ambient conditions for one hour. Subsequent to the preparation of the film and the printed transfer, the two articles were placed in a heat press 9 with the ink side 5 of the printed transfer 8 being placed in contact with the coated side of the film 2. The heat press 9 was pre-set at 365 F. Within the press silicone rubber was employed to encase the printed and print receptive assembly and prevent creasing and high-low heat and pressure spots. Using heavy pressure the press remained closed for 6 minutes. Following the press cycle the film was removed and the image had diffused from the transfer paper right through the white coating and was completely and clearly visible from both the uncoated side of the film and the coated side of the film. Thus a double sided photograph 20 in true continuous tone dye sublimation had been produced.

In the second embodiment of the present invention, depicted in drawing ref#2, an image-ready film was prepared by spray coating a nano 3 whitened UV-Curable urethane polymer coating layer 2 upon a clear extruded film 1.

In the third embodiment of the present invention, depicted in drawing ref#3 an image-ready film was prepared by co-extrusion. A clear polymer layer 1 was extruded and bonded to a secondary extruded layer 2 that contained the nano whitening additives 3.

In the fourth embodiment of the present invention, depicted in drawing ref#4 the imaged double-sided-photograph 20 is positioned in a clear acrylic frame 21, and remains viewable from both sides.

In the fifth embodiment of the present invention, depicted in cross-sectional drawing ref#5 the imaged double-sided-photograph 20 is located within a clear acrylic frame 21, remains visible from both sides, and is permanently encapsulated using a UV curable resin 11 to seal the void within which the photo is located, and to seal the outer perimeter of the assembly.

In the sixth embodiment of the present invention, depicted in drawing ref #6 the imaged double-sided-photograph 20 is subject to doming 10 on one side; which incorporate a doming resin 10 being applied to one side of the photograph 20 before curing to form a clear hard protective finish on one side of the photo.

In the seventh embodiment of the present invention, depicted in drawing ref #7 the imaged a rigid polycarbonate sheet-stock 12 has been coated with a UV curable dye-receptive layer 2 containing nano particulate of alumina 3

The foregoing description of the invention illustrates and describes the present invention. Additionally, the disclosure shows and describes only the preferred embodiments of the invention, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims to be construed to include alternative embodiments.

While specific embodiments have been illustrated and described, numerous modifications come to mind without significantly departing from the spirit of the invention and the scope of protection is limited by the scope of the accompanying claims.

1. A medium comprising an optically clear polymeric film or sheet-stock of a thickness exceeding 25 microns and capable of withstanding exposure to temperatures exceeding 280 F; adjacent to and bonded with a synthetic organic white translucent dye-receptive film or coating of a thickness ranging from 10-150 microns and also capable of withstanding exposure to temperatures exceeding 280 F

2. A graphically imaged media comprising a bi-layered polymer assembly described in claim 1, wherein the white organic polymer has been colored by the diffusion of disperse dyes

3. A graphically imaged media comprising a bi-layered polymer assembly described in claim 1, wherein the white organic polymer has been colored by the adsorption of graphic inks

4. A white translucent film described in claim 1, containing whitening particulate comprising semi-transparent particulate in the range of 1-400 nm in mean size.

5. A white translucent film described in claim 1, containing whitening particulate comprising semi-transparent particulate in the range of 1-400 nm in mean size combined with particulate greater than 400 nm

6. A white translucent film described in claim 1, containing kaolin clay, silica, or calcium carbonate

7. A white translucent film according to claim 1, comprising optical brightening agents or other fluorescing agents

8. A polymeric binder layer according to claim 1, comprising a polyester chemistry or hybrid thereof.

9. A polymeric support layer according to claim 1, comprising an extruded organic polyester film

10. A polymeric support layer according to claim 1, comprising an extruded organic polycarbonate sheet stock with a thickness of between 0.010″ and 1.00″

11. A process involving applying a translucent dye receptive white polymeric film or coating to a transparent film and diffusing disperse dyes into the translucent film or coating using heat and pressure so as to create a double sided translucent photograph

12. The process according to claim 11 employing the use of an inkjet printer containing disperse dyes, and heat press device to transfer an image from a printed carrier medium to the dye receptive polymeric surface

13. The process according to claim 11 employing a dye sublimation photo printer wherein the image is printed and transferred simultaneously into the white dye-receptive polymer

14. A process of applying a laminate, additional protective coating, or doming resin to one or both sides of a double sided photograph to add support and enhance the appearance of the product

15. A product according to claim 1 comprising an additional photo-luminescent layer or being employed adjacent to a photo-luminescent layer; that enables the dye impregnated layer to be illuminated in the darkness

16. A product according to claim 1 comprising a dye-cut or laser cut double-sided photograph positioned in a dye-cut or laser cut clear plastic frame of the same shape

17. A product according to claim 1 applied to glass windows so to create a digital stained glass appearance

18. A product according to claim 1, being thermoformed into a 3 dimensional article

19. A product according to claim 1, comprising a double-sided photograph permanently sealed inside a transparent glass or acrylic frame
